(19) United States
(12) Patent Application Publication
(10) Pub. No.: US 2017/0337609 A1
(43) Pub. Date: Nov. 23, 2017

(54) METHODS AND SYSTEMS FOR BACK-END SERVER USER INVENTORY INTEGRATION

(71) Applicant: Powersports Support, LLC, Santa Ana, CA (US)

(72) Inventors: Hakan Turemen, Santa Ana, CA (US); Jason Nichols, Irvine, CA (US); Adam Nichols, Irvine, CA (US)

(73) Assignee: Powersports Support, LLC, Santa Ana, CA (US)

(21) Appl. No.: 15/158,428

(22) Filed: May 18, 2016

(51) Int. Cl. G06Q 30/06

(52) U.S. Cl. CPC G06Q 30/0623; G06Q 30/0633

(57) ABSTRACT

A non-transitory storage medium having stored thereon program instructions, the program instructions being executable by one or more processors to perform a plurality of operations comprising receiving a first message including information particular to a webpage being loaded on an endpoint device, the webpage associated with a third-party shopping cart platform, parsing one or more packets comprising the first message to determine a product to be displayed on the webpage, analyzing a database storing contents of a product catalog to determine a first set of attributes of the product based on the first message, and providing a response including one or more of data or a first set of instructions associated with displaying the first set of attributes on the webpage.

### FIELD OF THE INVENTION

Embodiments of the disclosure relate to the field of e-commerce. More specifically, embodiments of the disclosure relate to systems, methods and an apparatus for facilitating customizable merchandise catalog integration with a third-party shopping cart platform.

### BACKGROUND

Recently, consumers have taken to the Internet to do much of their shopping. Online shopping enables consumers to shop from any geographic location, at any day of the week and at any time of the day. Online shopping, which takes places via the Internet, typically comprises a consumer using an electronic device to visit a website, the consumer selecting one or more items for sale on the website (e.g., adding the items to a shopping cart), and completing purchase of the selected items (e.g., “checking out” the items in the shopping).

In order for the consumer to have an enjoyable and seamless experience, the merchant must ensure that the items for sale are correctly displayed by the website. Specifically, once a consumer decides to purchase an item and prior to adding the item to the website's online shopping cart, the consumer may be required to select from one or more options associated with the item (e.g., size, color, year, make, model, or the inclusion accessories). At this juncture, the integration of the merchant's product catalog with the shopping cart platform is critical in ensuring a seamless experience of the consumer.

The merchant's product catalog consists of inventory for each item, including each option-combination, that the merchant has available. The product catalog schema (e.g., the manner in which the product catalog is structured) may be customized by the merchant to fit its particular business needs. For example, a merchant's business needs may require a specialized schema that allows for a vast number of options for each item. Alternatively, or in addition, a particular industry may have something akin to an industry-standard for the product catalog schema used by merchants within that industry.

However, third-party shopping cart platforms do not allow for varied product catalog schemas. Instead, third-party shopping cart platforms require a merchant to adhere to strict requirements set forth by the third-party shopping cart platform in order to seamlessly integrate its product catalog with the third-party shopping cart platform. Often times, the schemas required by the third-party shopping cart platform vary, or even completely contrast, the preferred schema of a merchant. Thus, in order to seamlessly integrate its product catalog with a third-party shopping cart platform so that the third-party shopping cart may be utilized on the merchant's website, a merchant must reorganize its product catalog, or at least provide the third-party shopping cart platform with an adjusted product catalog that adheres to the schema required by the third-party shopping cart platform.

As the schemas of many merchants' product catalogs do not adhere to the schemas required by third-party shopping cart platforms, integrating a product catalog with a third-party shopping cart platform requires a considerable amount of manual work on behalf of the merchant to either reorganize its product catalog or provide the third-party shopping cart platform with product information in a manner that adheres to the required schema. Additionally, as the merchant's product catalog changes or expands, additional manual work is required to provide the third-party shopping cart platform with updated product information in a manner that adheres to the required schema. Thus, current third-party shopping cart platforms provide an inadequate service and an unsatisfactory experience to many merchants.

Additionally, webpages associated with an e-commerce website should be crawlable and indexable by Internet search engines so that the webpages appear as search results when consumers use the search engines from an endpoint device.

### BRIEF DESCRIPTION OF THE DRAWINGS

Embodiments of the invention are illustrated by way of example and not by way of limitation in the figures of the accompanying drawings, in which like references indicate similar elements and in which:

FIG. 1 is an exemplary block diagram illustrating an e-commerce system including a Powersports Support (PSS) server.

FIG. 2 is an exemplary block diagram illustrating the Powersports Support Attribute Integration System (AIS) of FIG. 1.

FIG. 3 is an exemplary embodiment of a logical representation of the Powersports Support Attribute Integration System of FIG. 1.

FIG. 4 is a flowchart illustrating an exemplary method for describing one embodiment of the overall flow.

FIG. 5A is a flowchart illustrating a first portion of an exemplary method of integrating a merchant's product catalog in a website using the Powersports Support Attribute Integration System of FIG. 2.

FIG. 5B is a flowchart illustrating a second portion of an exemplary method of integrating a merchant's product catalog in a website using the Powersports Support Attribute Integration System of FIG. 2.

FIG. 6 is an exemplary block diagram of a sample webpage in which the AIS of FIG. 1 has integrated a product and a plurality of attributes.

### DETAILED DESCRIPTION

Various embodiments of the disclosure relate to an attribute integration system that improves the integration of a merchant's product catalog with a third-party shopping cart platform by acting as an intermediary that receives a request to display an item on a consumer's electronic device, parses and extracts information from the request, generates instructions for displaying the item with the appropriate selectable attributes corresponding to the merchant's product catalog. In one embodiment, the attribute integration system causes the item to be displayed within a display portion that is (i) embedded within the webpage of the merchant's web site, wherein display of the embedded portion is typically handled by the third-party shopping cart platform. For instance, this may mean that, when the attribute integration system is not present, the third-party shopping cart platform executes logic to display the product image and one or more attributes. Additionally, the attribute integration system facilitates integration between the third-party shopping cart platform and the merchant's product catalog such that the integration is agnostic to the schema required by the third-party shopping cart platform and the schema of the merchant's product catalog.

In one embodiment of the disclosure, responsive to a user activating a link via an endpoint device (e.g., an electronic device), the loading of a requested webpage of a merchant's website is initiated. During loading of the requested webpage, a portion of logic embedded within the webpage code is executed, which results in the transmission of a message from the logic to the attribute integration system. In one embodiment, the message is a Hypertext Transfer Protocol (HTTP) request (e.g., a HTTP POST request). The attribute integration system extracts information from the HTTP request and based on the extracted information, determines a product and one or more attributes that are to be displayed on the requested webpage. In one embodiment, at least a portion of the requested webpage is displayed by a third-party shopping cart platform, wherein the integration between the third-party shopping cart platform and the merchant's product catalog enables the webpage to accurately display one or more products and one or more corresponding attributes. Thus, the attribute integration system facilitates integration of the merchant's website with the third-party shopping cart platform by (i) receiving information regarding the requested webpage, (ii) determining the appropriate item and corresponding attributes to display, (iii) generating data and/or instructions associated with displaying one or more attribute selection mechanisms (e.g., dropdown menus) according to the item and attributes that are to be displayed, and (iv) providing the data and/or instructions to logic comprising the webpage, the logic parses, interprets and/or executes the data and/or instructions and alters the portion of the webpage embedded within the webpage of the merchant's website, wherein display of the embedded portion is typically handled by the third-party shopping cart platform.

In some embodiments, a user may select an option of each of one or more attributes of an item displayed on the webpage via the user's endpoint device. Responsive to receiving a second message transmitted as a result of a selection of an option of a first attribute, the attribute integration system again parses the second message and extracts information from the message (e.g., the selected option of the first attribute). In one embodiment, the second message may be based on either the HTTP GET or POST method implemented using Ajax (asynchronous JavaScript and XML), for example, using a XMLHTTPRequest (XHR) object. Based on the extracted option, the attribute integration system determines whether the webpage display needs to be altered by, for example, adding to, or removing from, the currently displayed attributes, or whether no further attributes are available for selection based on the selected attribute(s). In one embodiment, the attribute integration system provides data and/or instructions associated with altering the webpage in the form of an Ajax response, which is received, parsed and utilized by a portion of the code comprising the webpage. Example formats of the Ajax response may include, but are not limited or restricted to, a XML document, a HTML code snippet (e.g., a segment of HTML code that does not comprise a complete HTML page), a JavaScript Object Notation (JSON) string, etc.

When the webpage display needs to be altered to add or remove one or more attributes, the attribute integration system determines the one or more attributes to add or remove, and provides data and/or instructions that are received by the logic comprising the webpage, the data and/or instructions providing details as to how to alter the webpage display according to the merchant's product catalog and the one or more selections by the endpoint device user.

When no further attributes are available for selection based on the selected option(s), the attribute integration system provides instructions to the user's endpoint device for displaying an icon (e.g., a button) enabling the item including all selected options to be added to the third-party shopping cart, thus allowing the user to check-out.

In order to maintain crawlability and indexability of the webpages of the merchant's website and implement the attribute integration system, some information for each webpage is maintained on a first server hosting the third-party shopping cart platform. For example, the product names and descriptions may be maintained on the server hosting the third-party shopping cart platform wherein other information pertaining to the merchant's product catalog (e.g., attributes and options of each item) is maintained on a separate, second server hosting the attribute integration system. Therefore, webpages stored on the first server hosting the third-party shopping cart platform include information pertaining to the items for sale by the merchant, thus enabling the webpages to be crawlable and indexable by web crawlers associated with search engines.

A first benefit of storing the merchant's product catalog on a server hosting the attribute integration system being separate from the server hosting the third-party shopping cart platform is that the proprietary of the information within the merchant's product catalog is maintained such that the third-party shopping cart platform has no control over such information and is unable to utilize that information with other websites and other merchants. For example, when a merchant's product catalog data is stored by the third-party shopping cart platform, the catalog data may be easily disseminated by the third-party. Thus, by maintaining separation between the server hosting the attribute integration system and the server hosting the third-party shopping cart platform, the merchant improves its ability to maintain the proprietary manner of the catalog data.

A second benefit of maintaining separation between the server hosting the attribute integration system and the server hosting the third-party shopping cart platform is that migration by the merchant from using a first third-party shopping cart platform to a second third-party shopping platform does not require an arduous conversation of the catalog data into the required schema of the second third-party shopping cart platform.

A third benefit of maintaining separation between the server hosting the attribute integration system and the server hosting the third-party shopping cart platform is that, when the merchant's catalog data is used with multiple platforms, an update to the merchant catalog data and/or schema is only required in a single instance. In contrast, the merchant's catalog data is stored on a plurality of third-party servers for use with multiple platforms, an update to the catalog data and/or schema may require updating each instance of the catalog data and/or schema.

### Terminology

In the following description, certain terminology is used to describe features of the invention. For example, in certain situations, the term “logic” and “component” are representative of hardware, firmware or software that is configured to perform one or more functions. As hardware, a component (or module or logic) may include circuitry having data processing or storage functionality. Examples of such circuitry may include, but are not limited or restricted to a hardware processor (e.g., microprocessor with one or more processor cores, a digital signal processor, a programmable gate array, a microcontroller, an application specific integrated circuit “ASIC,” etc.), a semiconductor memory, or combinatorial elements. Herein, in one or more embodiments, the term “system” should be understood as comprising or including logic.

Alternatively, the component (or module or logic) may be software, such as executable code in the form of an executable application, an Application Programming Interface (API), a subroutine, a function, a procedure, an applet, a servlet, a routine, source code, object code, a shared library/dynamic load library, or one or more instructions. The software may be stored in any type of a suitable non-transitory storage medium, or transitory storage medium (e.g., electrical, optical, acoustical or other form of propagated signals such as carrier waves, infrared signals, or digital signals). Examples of non-transitory storage medium may include, but are not limited or restricted to a programmable circuit; semiconductor memory; non-persistent storage such as volatile memory (e.g., any type of random access memory “RAM”); or persistent storage such as non-volatile memory (e.g., read-only memory “ROM,” power-backed RAM, flash memory, phase-change memory, etc.), a solid-state drive, hard disk drive, an optical disc drive, or a portable memory device. As firmware, the executable code may be stored in persistent storage.

The term “computing device” should be construed as electronics with the data processing capability and/or a capability of connecting to any type of network, such as a public network (e.g., Internet), a private network (e.g., a wireless data telecommunication network, a local area network “LAN”, etc.), or a combination of networks. Examples of a computing device may include, but are not limited or restricted to, the following: a server, an endpoint device (e.g., a laptop, a smartphone, a tablet, a desktop computer, a netbook, a medical device, or any general-purpose or special-purpose, user-controlled electronic device); a mainframe; a router; or the like.

A “message” generally refers to information transmitted in one or more electrical signals that collectively represent electrically stored data in a prescribed format. Each message may be in the form of one or more packets, frames, HTTP-based transmissions, or any other series of bits having the prescribed format.

The term “computerized” generally represents that any corresponding operations are conducted by hardware in combination with software and/or firmware.

The term “communicatively coupled” generally refers to any coupling that enables transmission of a message. Examples of communicatively coupling include, but are not limited or restricted to, a hardwire link or a wireless link, such as via a private or public network, or combination thereof, or via Bluetooth®.

The term “third-party shopping cart platform” generally refers to an electronic system that enables the website of a merchandiser to process a purchase order completed by an endpoint user via a webpage of the website. Typically, the user selects one or two attributes of the item desired for purchase (e.g., color and/or size) via the webpage. Upon activating an icon or the like to complete the purchase, the third-party shopping cart platform may request payment and shipping information.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps or acts are in some way inherently mutually exclusive.

The invention may be utilized for facilitating integration of a merchant's product catalog with a third-party shopping cart platform. As this invention is susceptible to embodiments of many different forms, it is intended that the present disclosure is to be considered as an example of the principles of the invention and not intended to limit the invention to the specific embodiments shown and described.

II. Attribute Integration System (AIS) Implementation

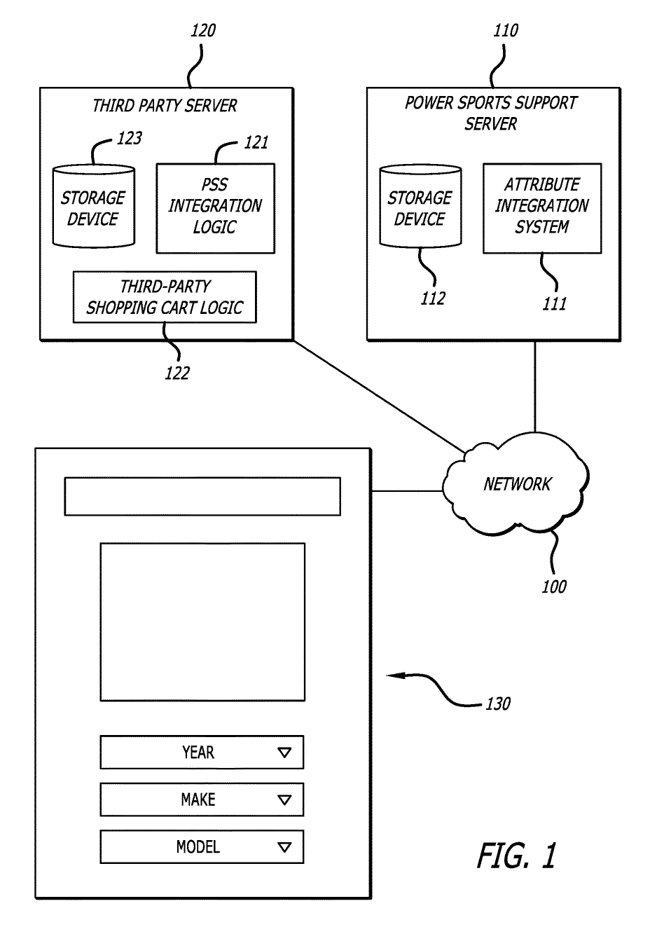

Referring to FIG. 1, is an exemplary block diagram illustrating an e-commerce system including a Powersports Support (PSS) server implementing an attribute integration system connected to a network is shown. The network 100 connects a PSS server 110 with a third-party server 120 and a user's endpoint device 130. The third-party server 120 includes (i) a third-party shopping cart platform logic 122 and interacts with the endpoint device 130 to display at least a portion of a webpage associated with a merchant's website, (ii) a PSS integration logic 121 embedded into the code comprising one or more webpages stored on the third-party server 120, and (iii) a storage device that stores the one or more webpages as well as product information associated with products for sale that are to be displayed on the one or more webpages. As discussed above, the product information stored on the storage device 123 enables the one or more webpages to be crawlable and indexable by search engines; thus, even though the merchant's product catalog is stored on the PSS server 110, the one or more webpages stored on the third-party server 120 remain crawlable and indexable.

In one embodiment, the endpoint device 130 is used to by a consumer to request a webpage of a merchant's web site (herein, a web site is generally comprised of one or more associated webpages). The requested webpage may include a display of a product for purchase via the merchant's website, wherein the purchase of the product includes the selection of one or more options (e.g., attributes). For example, a product for purchase may be a motorcycle helmet that comes in a variety of sizes and colors, and also includes options such as a shade system and a face visor, wherein the face visor comes in a variety of colors as well. Thus, the requested webpage that enables the consumer to purchase the helmet will need to include the ability to allow the consumer to select the helmet having the desired attributes.

Typically, when a webpage displaying a product for purchase is requested, the third-party shopping cart platform displays at least portion of the webpage. Specifically, the third-party shopping cart platform will display an image of the product and options to select one or more attributes. Thus, in order for the third-party shopping cart platform to properly display the product and options, the merchant's product catalog must adhere to the specifications set forth by the third-party shopping cart platform. As discussed above, the schema of the merchants' product catalog may not adhere to the required schema of the third-party shopping cart platform.

However, the attribute integration system includes an integration logic embedded within the webpage code (e.g., JavaScript included within the Hypertext Markup Language (HTML) code) such that, when a particular webpage is requested pertaining to a product for purchase, the integration logic transmits a message (e.g., a HTTP POST request) to logic stored on a separate server (e.g., the Powersports Support server 110), which parses the message to determine the product requested. Subsequently, the logic on the server 110 analyzes the database storing the merchant's product catalog, determines any available attributes based on the merchant's product catalog in its preferred schema, and returns data and/or instructions for properly displaying available attributes in a manner that adheres to the schema requirements set forth by the third-party shopping cart platform to the logic comprising the webpage being displayed. In one embodiment, the network 100 facilitates the transmission of the webpage request and the message between the integration logic and the logic stored on the server 110.

Subsequent to the rendering of the webpage displaying the product for purchase and the applicable attributes, upon receiving a selection of an option of a first attribute, a second message is transmitted to the AIS (e.g., the second message may be an HTTP Post request implemented using Ajax), the AIS then determines the selection made by the consumer, analyzes the database storing the merchant's product catalog to determine any available attributes in light of the first selected attribute (e.g., a selection of a first attribute may result in the removal of the ability to select another attribute), and return data and/or instructions for properly displaying the updated available attributes along with the selected attribute.

The process of selecting attributes and updating the webpage may continue until the consumer selects an attribute, or combination of attributes, such that the logic stored on the server 110 determines the attributes have been filtered down such that there are no further attributes from which to select based on the already-selected attribute, or attribute combination (herein, such a situation may be referred to as “absolutely filtered”). At this point, the logic stored on the server 110 returns instructions for displaying the most updated attribute selection(s) and for displaying a button/icon for purchasing the product having the selected attribute(s) (e.g., “checking-out”).

1. Attribute Integration System (AIS) Framework

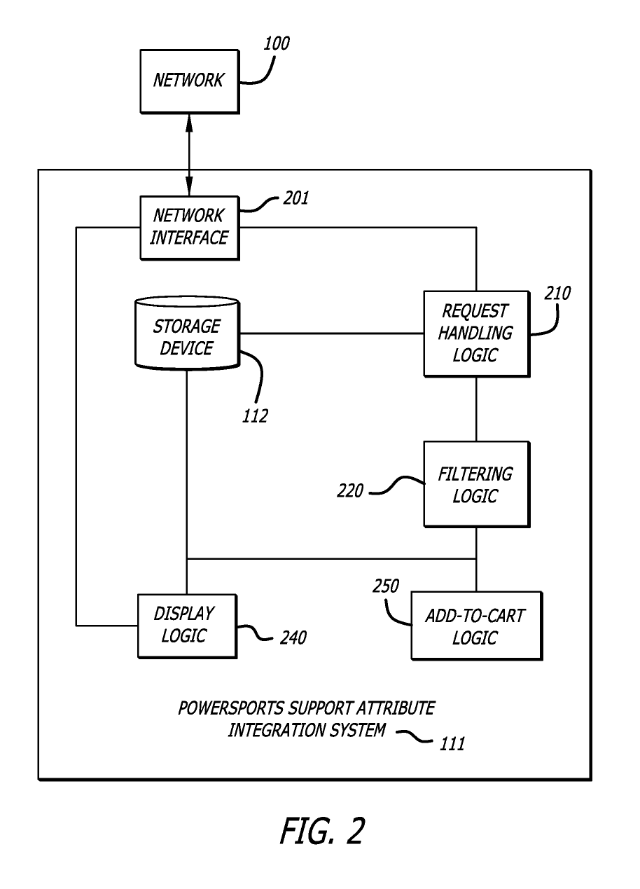

Referring to FIG. 2, an exemplary block diagram illustrating the Powersports Support Attribute Integration System (AIS) of FIG. 1 is shown. The AIS 111 includes a network interface 201, a storage device 112, a request handling logic 210, a filtering logic 220, an add-to-cart logic 230 and a display logic 240. The network interface 201 provides the delivery and reception mechanism used by the AIS 111 for inbound and outbound communications used during request fulfillment. The storage device 112 stores data representing the merchant's product catalog as provided by the merchant, e.g., in the preferred schema of the merchant.

The request handling logic 210 converts, or transforms, inbound messages from a first format (e.g., the format set forth for HTTP requests in RFC 2616) to a second format that is useable by the filtering logic 220. For example, the request handling logic 210 may parse a HTTP Post request transmitted by the integration logic 121 of FIG. 1 to determine a product to display on a requested webpage and pass the product name to the filtering logic 220.

The filtering logic 220 receives information extracted from a received message by the request handling logic 210. For example, the filtering logic 220 may receive a representation of a product that is to be displayed on the requested webpage. The representation may take any form, such as, for example, a text string or a numerical string, wherein the representation may be used to index at least a portion of the storage device 202 (e.g., the database including the merchant's product catalog). Upon receiving the information, the filtering logic 220 analyzes the database including the merchant's product catalog to locate the product to be displayed on the requested webpage, and subsequently determines one or more attributes associated with the product. The one or more attributes may include all attributes associated with the product or the one or more attributes may include a first subset of all attributes associated with the product (e.g., less than all), wherein all attributes or a second subset may be displayed upon the selection of an option of a first attribute from the first subset. In one embodiment, the determination of the one or more attributes to display may be based on one or more set of predefined rules. Upon determining the one or more attributes that are to be displayed on the webpage, the one or more attributes are provided to the display logic 240.

The add-to-cart logic 230 receives a notification from the filtering logic 220 that no further alterations to the display of attributes is needed (e.g., the user has selected one or more attributes that the selection is “absolutely filtered,” meaning no further selections need to be made prior to adding the product having the selected options to a virtual shopping cart, or purchasing the product having the selected options). The add-to-cart logic 230 provides the logic comprising the webpage being displayed with data and/or one or more instructions associated with altering the display of the webpage to include an additional icon that enables an “add-to-cart” procedure or enables the purchase of the product. In one embodiment, the one or more instructions are provided to the display logic 240, which transmits the one or more instructions to the logic comprising the webpage being displayed.

The display logic 240 receives one or more attributes from the filtering logic 220 and generates data and/or one or more instructions associated with altering a portion of the display of the webpage on the user's endpoint device. The instructions may be in any software language that is understandable by the endpoint device (or an application or program installed thereon). The data may include, for example, the attributes to be displayed according to the filtering. The data and/or generated display instructions are transmitted to the logic comprising the webpage and upon parsing, interpretation and/or execution, cause the logic comprising the webpage to alter the display of the webpage by displaying one or more additional attributes, one or more fewer attributes, or an additional icon on the webpage that enables the purchase of the product (or facilitates an “add-to-cart” procedure). Specifically, the data and/or instructions are provided to directly the logic comprising the webpage, which alters a portion of the webpage displayed by the third-party server 120. This may be referred to as overriding the third-party shopping cart platform's logic for generating a display.

For example, previous technologies require that the merchant's product catalog be provided to the third-party server 120 in a prescribed scheme in order for the product and attributes to be retrieved and displayed properly. In contrast, one embodiment of the present disclosure enables the merchant's product catalog to be presented to the AIS 111 in any schema desired by the merchant and the display logic 240 will provide the logic comprising the webpage with data and/or instructions for displaying one or more attributes properly within the portion of the webpage displayed by the third-party server 120.

2. Logical Representation

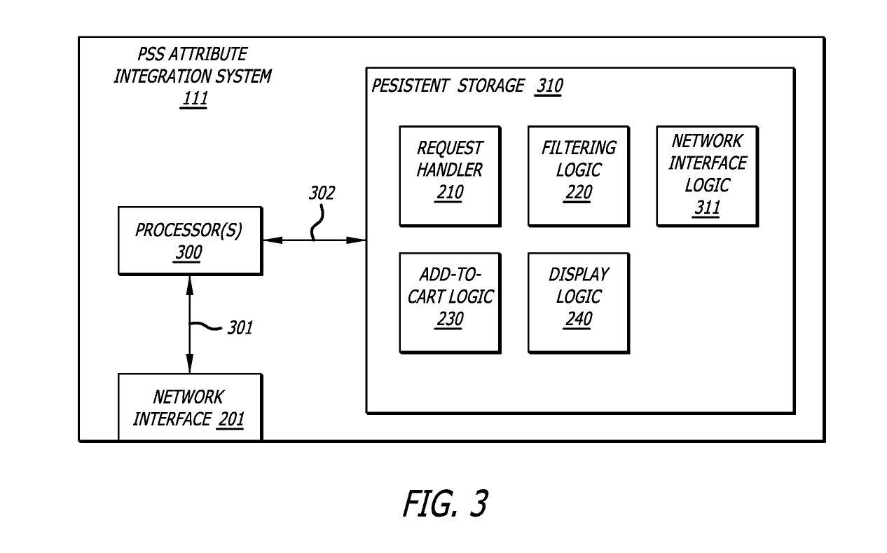

Referring to FIG. 3, an exemplary embodiment of a logical representation of the attribute integration system of FIG. 1 is shown. The PSS attribute system 111 includes one or more processors 300 that are coupled to communication interface 201 via a first transmission medium 301. The network interface 201, and the network interface logic 311 located within a persistent storage 210, enables communication with network devices via the Internet and one or more the endpoint devices. According to one embodiment of the disclosure, the network interface 201 may be implemented as a physical interface including one or more ports for wired connectors. Additionally, or in the alternative, the network interface 201 may be implemented with one or more radio units for supporting wireless communications with other electronic devices.

The processor(s) 300 is further coupled to persistent storage 310 via a second transmission medium 302. According to one embodiment of the disclosure, persistent storage 310 may include (a) a request handler 210, (b) a filtering logic 220, (c) an add-to-cart logic 230, (d) a signatures database 124, and (e) the network interface logic 311. Of course, when implemented as hardware, one or more of these logic units could be implemented separately from each other.

3. Attribute Integration Methodology

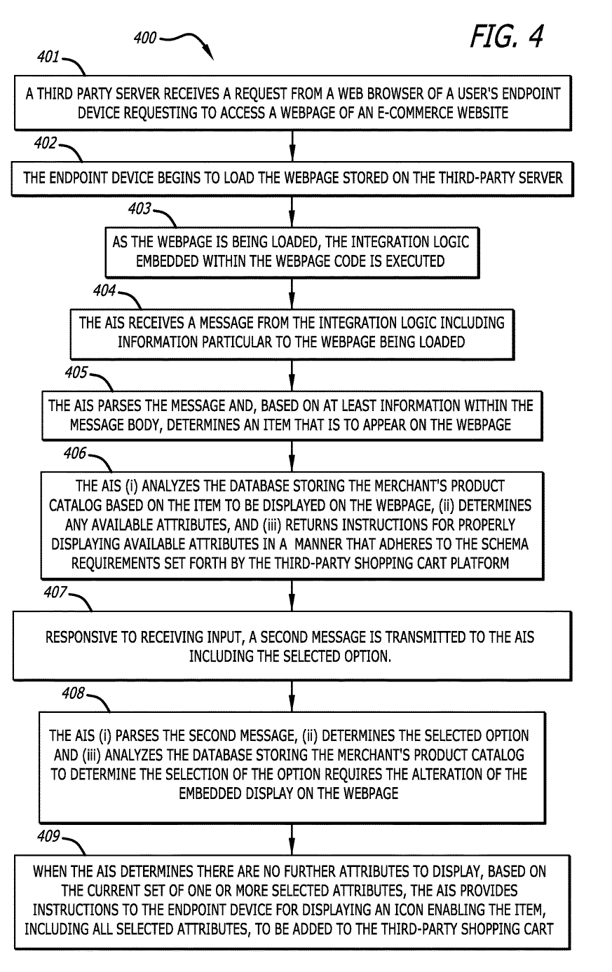

Referring to FIG. 4, a flowchart illustrating an exemplary method for describing one embodiment of the overall flow is shown. Each block illustrated in FIG. 4 represents an operation performed in the method 400 of one embodiment of the Powersports Support Attribute Integration System (AIS) integration within a third-party shopping cart platform. Referring to FIG. 4, a third-party server receives a request from a web browser of a user's endpoint device requesting to access a webpage of an e-commerce website (block 401). At block 402, the endpoint device begins to load the webpage stored on the third-party server (e.g., associated with the e-commerce website). At block 403, as the webpage is being loaded, the integration logic embedded within the webpage code is executed. In one embodiment, the integration logic may be a section of JavaScript code that is embedded into the HTML code comprising the webpage. At block 404, the AIS receives a message from the integration logic. Specifically, the execution of the integration logic causes a message to be to transmitted, by the integration logic, to the AIS including information particular to the webpage being loaded. In one embodiment, the message may be a HTTP POST request. At block 405, the AIS parses the message and, based on at least, for example, information within the message body, determines an item that is to appear on the webpage (e.g., an item for sale).

At block 406, the AIS (i) analyzes the database storing the merchant's product catalog based on the item to be displayed on the webpage, (ii) determines any available attributes based on the merchant's product catalog in its preferred schema, and (iii) returns instructions for properly displaying available attributes in a manner that adheres to the schema requirements set forth by the third-party shopping cart platform.

At block 407, responsive to receiving input (e.g., the selection of an option of an attribute), the integration logic transmits a second message to the AIS including the selected option. In one embodiment, the selection of an option may trigger an Ajax request transmitted to the AIS server. As an example, the selection of the option may be transmitted to the AIS server using a GET or POST method.

At block 408, the AIS parses the second message and determines the selected option. Upon determining the selection option, the AIS analyzes the database storing the merchant's product catalog to determine the selection of the option requires the alteration of the embedded display on the webpage to display more or less attributes, or display an icon associated with a purchase procedure (e.g., “check-out”). When the AIS determines there are no further attributes to display, based on the current set of one or more selected attributes, the AIS provides instructions to the endpoint device for displaying an icon (e.g., a button) enabling the item, including all selected attributes, to be added to the third-party shopping cart, thus allowing the user of the endpoint device to check-out (block 409).

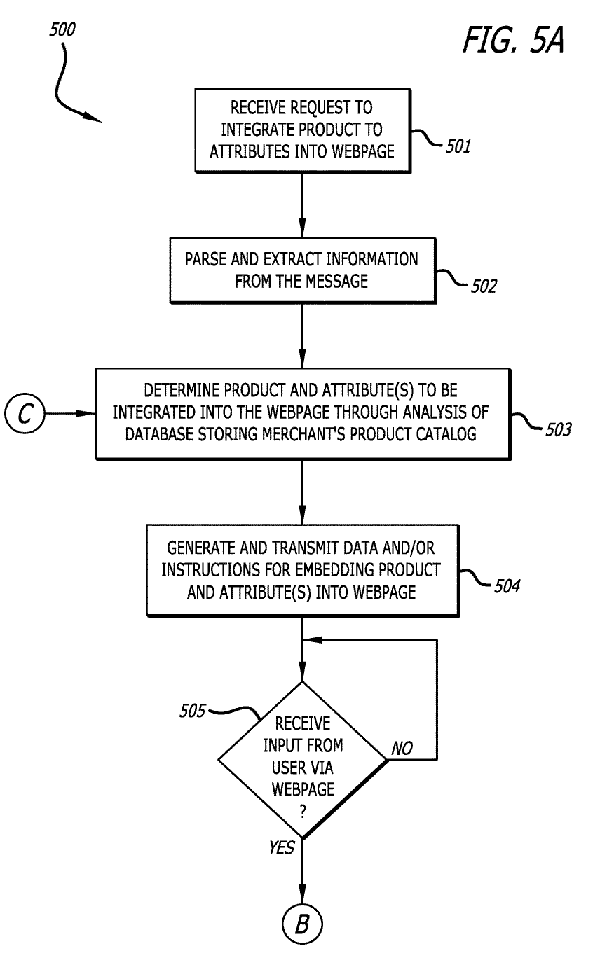

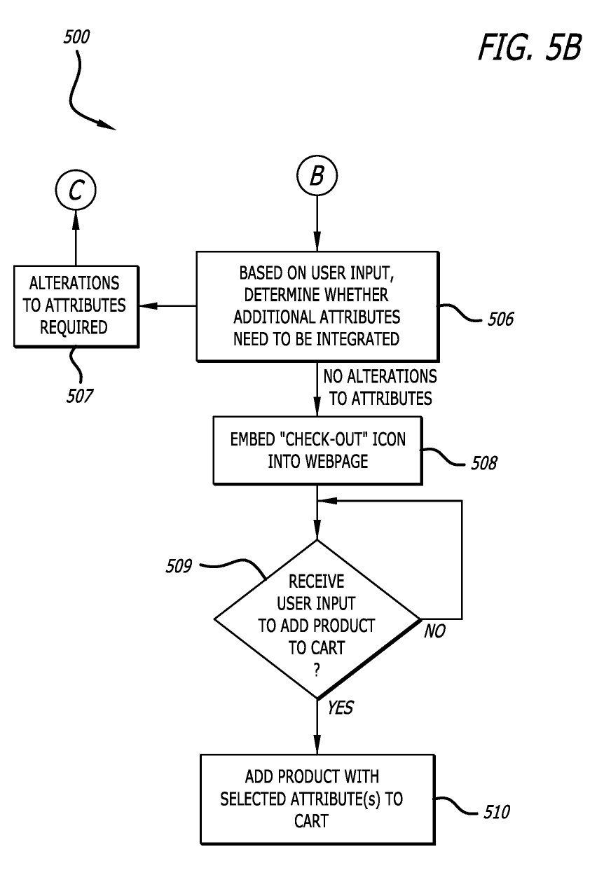

Referring to FIG. 5A, a flowchart illustrating a first portion of an exemplary method of integrating a merchant's product catalog in a web site using the Powersports Support Attribute Integration System of FIG. 2 is shown. Each block illustrated in FIGS. 5A and 5B represents an operation performed in the method 500 of a second embodiment of the Powersports Support Attribute Integration System (AIS) integration within a third-party shopping cart platform. Referring to FIG. 5A, AIS receives a message from an integration logic, wherein the integration logic is embedded in an e-commerce webpage associated with a third-party server platform requested by a user of an endpoint device and executed upon the request (block 501). In one embodiment, the message may be a HTTP Post request. At block 502, the AIS parses and extracts information from the message corresponding to a product that is to be displayed on the webpage. In one embodiment, the AIS parses a HTTP Post request by determining the content type based on reading the “Content-Type” field and subsequently decodes the values stored within the message body (e.g., the payload) when the content type is one supported by the AIS.

At block 503, the AIS determines the product to be displayed on the webpage based on the extracted information. As discussed above, in one embodiment, the AIS determines the product to be displayed on the webpage by decoding the message body, which will include a representation of the product to be displayed (e.g., a textual or numeric representation that the AIS may use as an index into the database, or translate prior to use as an index). Based on the product to be displayed on the webpage, the AIS analyzes the database storing the merchant's product catalog to determine one or more attributes that are to be displayed along with the product on the webpage.

At block 504, the AIS generates data and/or one or more instructions for embedding a representation of the product (e.g., an image) and the one or more attributes that have been determined to be displayed along with the product on the webpage. The data and/or one or more instructions are received by a portion of the logic comprising the webpage. The portion of the logic comprising the webpage parses and interprets the data and/or one or more instructions. Responsive to receiving, parsing and/or interpreting the data and/or one or more instructions, a portion of the logic comprising the webpage alters the current display of the webpage by altering a portion of the webpage, wherein the display of the portion of the webpage is typically handled by the third-party shopping cart platform. In one embodiment, the third-party shopping cart platform is unaware that the AIS is manipulating the display of the webpage. Importantly, by providing data and/or instructions directly to the logic comprising the webpage and the logic comprising the webpage parsing, interpreting and/or executing the data and/or instructions to alter the portion of the webpage display, the AIS is able to seamlessly integrate the content of the merchant's product catalog, set forth in the schema preferred by the merchant, without requiring the merchant to alter its product catalog schema. Additionally, as stated above, the merchant's catalog data is unusable by the third-party shopping cart platform when the schema of the merchant's catalog does not coincide with the required schema of the third-party shopping cart platform.

At block 505, when no further input regarding the displayed one or more attributes has been received by the webpage via the endpoint device, the AIS waits for such input (no at block 505). Referring to FIG. 5B, when further input regarding the displayed one or more attributes has been received by the webpage via the endpoint device (yes at block 505), a message is transmitted to the AIS responsive to receiving the input (e.g., a selection of a first attribute), the AIS parses the message and extracts information pertaining to the displayed product and the selected first attribute (block 506). Based on the extracted information, the AIS analyzes the database storing the merchant's product catalog and determines whether additional attributes need to be integrated into the display of the webpage and/or currently displayed attributes need to be adjusted or removed. In one embodiment, the AIS may determine that, based on the selected option of an attribute, one or more additional attributes are available for further selection by the user of the endpoint device. As one example, upon selection of an option of a first attribute of a product, the AIS may determine that, along with a second attribute that is already displayed via a dropdown on the webpage, a dropdown for a third attribute is to be displayed (e.g., the third attribute is not available with one or more of the options not selected by the user). In a second embodiment, upon selection of an option of a first attribute of a product, the AIS may determine that a dropdown representing a second attribute is to be removed from the webpage (e.g., the second attribute is not available with the selected option of the first attribute).

At block 507, when one or more alterations regarding the attributes to the webpage are to be made, the method 500 returns to block 503 to generate one or more instructions for altering the portion of the webpage displayed by the third-party shopping cart platform to alter the display of the one or more additional attributes.

At block 508, when no alterations regarding the attributes to the webpage are needed, the AIS provides data and/or one or more instructions within a response to a request received as a result of the user input, the data and/or one or more instructions instruct the webpage to display a “check-out” icon. Responsive to receiving the one or more instructions for altering the webpage to display the check-out icon, the logic comprising the webpage alters the webpage to display the check-out icon. In an alternative embodiment, the icon may be an “add-to-cart” icon that is used to add the displayed item to the third-party shopping cart and allow the user of the endpoint device to continue shopping on the website. It has also been contemplated that a “buy-now” or similar icon may be used that automatically adds the displayed item to the third-party shopping cart and uses stored billing information to complete the purchasing process.

At block 509, when input regarding the check-out of the displayed product has not been received by the webpage via the endpoint device, the logic comprising the webpage waits for such input (no at block 509). When input regarding the check-out of the displayed product has been received by the webpage via the endpoint device (yes at block 509), control of the check-out process is provided to the third-party shopping cart platform, which adds the displayed product and the corresponding selected attributes to the third-party shopping cart (block 510). The activation of the “check-out” icon may result in a request being transmitted to the third-party shopping cart platform to complete the purchasing process. In one embodiment, the request may comprise a HTTP POST request.

4. Attribute Integration Implementation

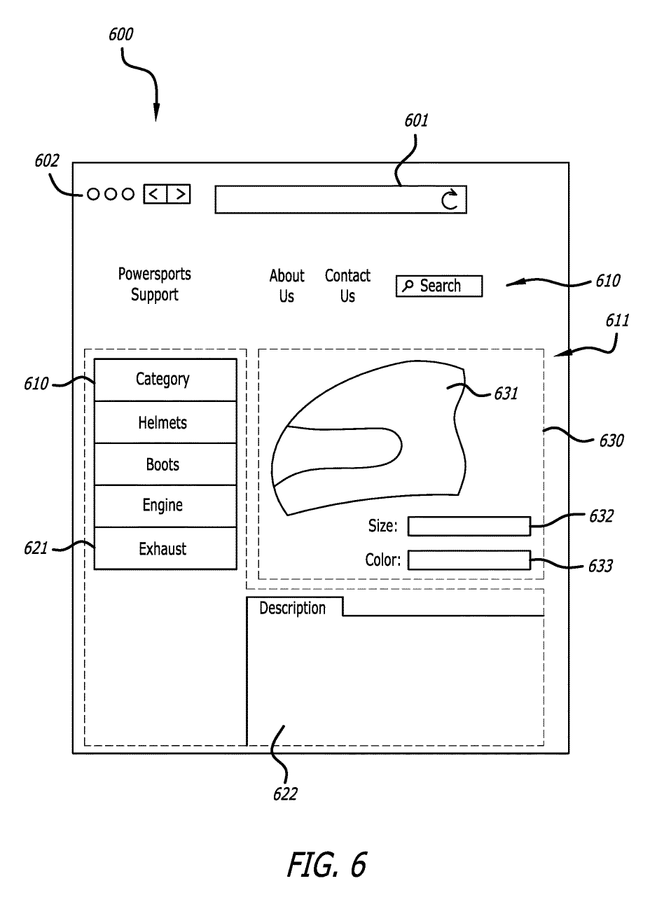

Referring to FIG. 6, is an exemplary block diagram of a sample webpage in which the AIS 111 of FIGS. 1 and 2 has integrated a product and a plurality of attributes is shown. The webpage is displayed within a web browser 600, which is shown to include an address bar 601 and function icons 602. The webpage is seen to include a header section 610 including a title, one or more links (“About Us” and “Contact Us”) and a search bar. The webpage also includes display section 611 having at least (i) a first portion 620 that includes a category bar 621 and a description portion 622, and (ii) a second portion 630 that may include at least a product image 631 and one or more attribute dropdown menus 632 and 633. Although FIG. 6 only illustrates two dropdown menus, the disclosure is not limited to two dropdown menus but may include one or more dropdown menus. Additionally, in one embodiment, the number of dropdown menus displayed within the second portion 630 may be dynamic such that responsive to user interaction, the number of dropdown menus displayed with the second portion 630 changes (e.g., the display of the second portion 630 is altered to display more or fewer dropdown menus).

In one embodiment, the first portion 620 may be provided for in the webpage code (e.g., HTML code) comprising the webpage that is provided by the owner of the website to which the webpage belongs (e.g., a merchant). For example, the category bar 621 may be provided for within the webpage code such that all webpages comprising the website include the category bar 621. In another embodiment, each webpage comprising the website that includes a display of a product image may include the description portion 622, wherein only text within the description portion 622 according to the product image displayed and the formatting remains the same. In other words, the contents displayed within the first portion 620 may be predetermined according to the Universal Resource Link (URL) of the webpage and not vary according to user interaction with elements of the second portion 630.

Additionally, in one embodiment, the contents of the second portion 630 may be associated with the URL of the webpage and be dynamic responsive to user interaction with the dropdown menus 632 and 633. In one example, the product image 631 and number of dropdown menus displayed may dynamically change responsive to user input received by a dropdown menu 632 or 633 (e.g., the color of the product illustrated in the product image 631 may change according to user input received by the dropdown menu 633). However, in such an example, the contents of the first portion 620 may not change.

Furthermore, the display of the second portion 630 is performed according to instructions generated by the AIS 111, as discussed above, which override logic of the third-party shopping cart platform thereby integrating the merchant's product catalog into the embedded display area typically handled by the third-party shopping cart platform. Specifically, the logic comprising the webpage receives data and/or instructions generated by the AIS 111 and displays the second portion 630 according to the received data and/or instructions.

In the foregoing description, the invention is described with reference to specific exemplary embodiments thereof. It will, however, be evident that various modifications and changes may be made thereto without departing from the broader spirit and scope of the invention as set forth in the appended claims.

What is claimed is:

1. A non-transitory storage medium having stored thereon program instructions, the program instructions being executable by one or more processors to perform a plurality of operations comprising:
receiving a first message including information particular to a webpage being loaded on an endpoint device, the webpage associated with a third-party shopping cart platform;
parsing one or more packets comprising the first message to determine a product to be displayed on the webpage;
analyzing a database storing contents of a product catalog to determine a first set of attributes of the product based on the first message; and
providing a response including one or more of data or a first set of instructions associated with displaying the first set of attributes on the webpage.

2. The storage medium of claim 1, wherein the analyzing of the database includes analyzing the contents of the product catalog based on the item to be displayed on the webpage according to a set of predefined rules, the database storing the contents of the product catalog being stored on a first server and the webpage being stored on a second server different than the first server.

3. The storage medium of claim 1, wherein the first message is a Hypertext Transfer Protocol (HTTP) Post request.

4. The storage medium of claim 1, wherein the first message is received from the logic embedded within code comprising the webpage.

5. The storage medium of claim 4, wherein the logic embedded within code comprising the webpage is JavaScript.

6. The storage medium of claim 1, wherein the program instructions being executable by the one or more processors to perform operations further comprises:
receiving a second message including information particular to an input corresponding to a selected option, the input received via the webpage;
parsing a second message;
determining the selected option; and
analyzing the database storing the contents of the product catalog to determine whether selection of the option requires alteration of a portion of the display of the webpage to display a second set of attributes, the second set of attributes being different than the first set of attributes.

7. The storage medium of claim 6, wherein the instructions being executable by the one or more processors to perform operations further including:
responsive to determining there are further attributes to display, provide a second set of instructions to logic embedded within code comprising the webpage to alter a display of the webpage to display the second set of attributes.

8. The storage medium of claim 6, wherein the program instructions being executable by the one or more processors to perform operations further comprises:
responsive to determining there are no further attributes to display, providing a third set of instructions to the logic embedded within code comprising the webpage to alter a display of the webpage to display an icon associated with a purchase procedure.

9. A method for integrating a product catalog with a third-party shopping cart platform comprising:
receiving a first message including information particular to a webpage being loaded on an endpoint device, the webpage associated with a third-party shopping cart platform;
parsing one or more packets comprising the first message to determine a product to be displayed on the webpage;
analyzing a database storing contents of a product catalog to determine a first set of attributes of the product based on the first message; and
providing a response including one or more of data or a first set of instructions associated with displaying the first set of attributes on the webpage.

10. The method of claim 9, wherein analyzing the contents of the database includes analyzing the contents of the product catalog based on the item to be displayed on the webpage according to a set of predefined rules, the contents of the product catalog being stored on a first server and the webpage being stored on a second server different than the first server.

11. The method of claim 9, wherein the first message is a Hypertext Transfer Protocol (HTTP) Post request.

12. The method of claim 9, wherein the first message is received from the logic embedded within code comprising the webpage.

13. The method of claim 12, wherein the logic embedded within code comprising the webpage is JavaScript.

14. The method of claim 9, further comprising:
receiving a second message including information particular to an input corresponding to a selected option, the input received via the webpage;
parsing a second message;
determining the selected option; and
analyzing the database storing the product catalog to determine the selection of the option requires the alteration of the embedded display on the webpage to display more or less attributes, or display an icon associated with a purchase procedure.

15. The method of claim 14, further comprising:
responsive to determining there are further attributes to display, provide a second set of instructions to the logic embedded within code comprising the webpage to alter a display of the webpage to display the second set of attributes.

16. The method of claim 14, further comprising:
responsive to determining there are no further attributes to display, provide a third set of instructions to the logic embedded within code comprising the webpage to alter a display of the webpage to display an icon associated with a purchase procedure.

17. A system for integrating a product catalog with a third-party shopping cart platform comprising:
a first set of one or more processors; and
a first persistent storage device communicatively coupled to the first set of one or more processors, the first persistent storage device having stored thereon an attribute integration system including logic that, when executed by the first set of one or more processors,
i. parses one or more packets comprising a first received message to determine a product to be displayed on a webpage, the first received message including information particular to the webpage being loaded on an endpoint device, the webpage associated with a third-party shopping cart platform,
ii. analyzes a database storing contents of a product catalog to determine a first set of attributes of the product based on the first message, and
iii. provides a response including one or more of data or a first set of instructions associated with displaying the first set of attributes on the webpage.

18. The system of claim 17 further comprising:
a second set of one or more processors; and
a second persistent storage device communicatively coupled to the second set of one or more processors, the second persistent storage device having stored thereon an integration logic embedded within the webpage associated with the third-party shopping cart platform, the integration logic that, when executed by the second set of one or more processors,
transmits the first message to the attribute integration system in response to loading of the webpage by a web browser.

19. The system of claim 17, wherein analyzing the database, by the attribute integration system, includes analyzing the contents of the product catalog based on the item to be displayed on the webpage according to a set of predefined rules.

20. The system of claim 17, wherein the logic of the attribute integration system, when executed by the first set of one or more processors,
iv. provides one or more of a second data or a second set of instructions to code comprising the webpage, the second data and the second set of instructions associated with displaying a second set of attributes, and
v. provides one or more of a third data or a third set of instructions to the code comprising the webpage, the third data and the third set of instructions associated with altering the display of the webpage to display an icon associated with a purchase procedure.
